(19) United States
(12) Patent Application Publication
(10) Pub. No.: US 2024/0290510 A1
(43) Pub. Date: Aug. 29, 2024

(54) A nuclear reactor module and a nuclear district heating reactor comprising and method of operating the same

(71) Applicant: Teknologian tutkimuskeskus VTT Oy, Espoo (FI)

(72) Inventors: Ville Tulkki, Espoo (FI); Jaakko Leppänen, Espoo (FI); Ville Hovi, Espoo (FI); Joona Kurki, Espoo (FI); Ville Valtavirta, Espoo (FI)

(21) Appl. No.: 18/253,660

(22) PCT Filed: Nov. 19, 2021
(86) PCT No.: PCT/FI2021/050788

§ 371 Date: May 19, 2023

(30) Foreign Application Priority Data
Nov. 20, 2020 (FI) 20206180

(51) Int. Cl. G21C 15/18; G21C 1/32; G21D 9/00

(52) U.S. Cl. CPC G21C 15/18; G21C 1/32; G21D 9/00

(57) ABSTRACT

According to an example aspect of the present invention, there is provided a nuclear reactor module which has a containment vessel and a reactor vessel contained inside the containment vessel. The reactor vessel contains a primary circuit with a primary fluid and a reactor core being cooled by the primary fluid. An intermediate volume is formed between the containment vessel and the reactor vessel. The intermediate volume is partially filled with an intermediate fluid. The circulation of the primary fluid is permanently separated from the intermediate volume.

### FIELD

The present invention relates to nuclear power. In particular, the invention relates to passive removal of decay heat after reactor shut-down.

### BACKGROUND

Nuclear safety relies on certain basic principles, such as the coolability of the nuclear fuel and the principle of defence-in-depth. The former refers to maintaining a sufficient coolant flow in the reactor core in order to avoid structural damage caused by over-heating. The requirement covers both normal operating and transient conditions, when the reactor is producing fission power, as well as all conditions in which the reactor has been shut down but significant residual heat is produced by radioactive decay (decay heat). Coolant flow can be maintained by active systems based on forced circulation or passive systems relying on natural convection. The current trend in reactor design is to replace electric pumps with passive systems which require no active measures to actuate or maintain the coolant flow. The defence-in-depth principle is based on the requirement that the radioactive isotopes in the nuclear fuel are isolated from the environment by multiple successive and independent barriers. The two outermost barriers relevant for this application are the primary circuit (in this case the reactor vessel) and the containment (in this case the containment vessel). A significant radioactive emission would require that fuel suffers considerable damage and that all successive release barriers would be breached.

One passive arrangement for passive cooling and decay heat removal is proposed in US 2010/0124303 A1. US 2010/0124303 A1 discloses a reactor core contained in a pressurised reactor vessel which is housed in an internally dry containment vessel which, in turn, is submerged in a pool of water. The dry space between the reactor and the containment vessel acts as a thermal insulation, enabling the reactor to operate at high temperature without significant heat losses. The reactor module features an emergency cooling system, which is actuated by opening two sets of valves in the reactor vessel. The containment space is flooded with water, which breaks the thermal insulation and enables natural circulation that transfers heat from the reactor core into the surrounding pool of water, i.e. the final heat sink.

There remains, however, a further need to improve the reliability of passive arrangements for removing decay heat of nuclear reactors which rely on mechanical elements which may, upon malfunction, introduce a failure point.

### SUMMARY OF THE INVENTION

The invention is defined by the features of the independent claims. Some specific embodiments are defined in the dependent claims.

According to a first aspect of the present disclosure, there is provided a nuclear reactor module which has a containment vessel and a reactor vessel contained inside the containment vessel. The reactor vessel contains a primary circuit with a primary fluid and a reactor core being cooled by the primary fluid. An intermediate volume is formed between the containment vessel and the reactor vessel. The intermediate volume is partially filled with an intermediate fluid. The intermediate fluid may be liquid, for example water. The circulation of the primary fluid is permanently separated from the intermediate volume.

According to a second aspect of the present invention, there is provided a nuclear district heating reactor featuring such a nuclear reactor module.

According to a third aspect of the present invention, there is provided a method of operating such a nuclear reactor module

Various embodiments of the first aspect may comprise at least one feature from the following itemized list:
the reactor vessel is configured to prevent all fluid flow between the reactor vessel and the containment vessel;
the reactor vessel is made of a thermally conducting material;
the temperature of the primary fluid at the downcomer is below the boiling point of the intermediate fluid;
the temperature of the primary fluid is lower than the boiling point of the intermediate fluid under normal operation mode of the nuclear reactor module;
the reactor vessel is pressurized to over pressure;
the over pressure is between 5 and 10 bar;
the nuclear reactor module is configured to operate in a normal operation mode and in a passive decay heat removal mode;
in the normal operation mode the temperature of the primary fluid at the downcomer is below the boiling point of the intermediate fluid;
in the normal operation mode the temperature of the intermediate fluid is below the boiling point of the intermediate fluid;
in the passive decay heat removal mode the temperature of the primary fluid at the downcomer is at or above the boiling point of the intermediate fluid;
in the passive decay heat removal mode the temperature of the intermediate fluid is at the boiling point of the intermediate fluid;
when the intermediate fluid boils, a thermally conductive passageway is formed between the nuclear core and the ambient or heat sink;
when in the passive decay heat removal mode, the temperature of the wall of the containment vessel is kept below the boiling point of the intermediate fluid for facilitating efficient heat transfer;
the efficient heat transfer occurs via the intermediate fluid boiling at the reactor vessel wall region and condensing to the containment wall region,
the efficient heat transfer is the primary heat transfer mechanism removing decay heat from the reactor core in the passive decay heat removal mode;
the passive removal of decay heat is not reliant on forced circulation of the primary or secondary fluid, or actuation of mechanical components;
the primary fluid is water;
the intermediate fluid is water;
the core outlet temperature is in a range of 120 . . . 150° C.;
the temperature of the primary fluid at the downcomer is below 100° C.;
the nuclear reactor module comprises a passive decay heat removal system provided by a heat conductive passageway between the reactor core and the surrounding ambient or heat sink, when the intermediate fluid is brought to its boiling point;
the reactor vessel does not comprise a thermal insulation;
primary circuit comprises a riser, a downcomer co-operatively associated with the riser, and a primary fluid,
the containment vessel is placed in a heat sink,
the heat sink is a pool of water,
the containment vessel is pressurized to an overpressure for increasing the boiling point of the intermediate fluid.

Considerable benefits may be gained with the aid of the present invention. Transfer from normal operation to passive decay heat removal mode occurs naturally when the primary heat transfer route from the primary circuit is compromised and the primary fluid temperature at the outlet of the heat exchanger increases high enough to induce boiling of the intermediate fluid. The established heat transfer route from the reactor core to the ultimate heat sink does not rely on the function of valves or any other mechanical components. Heat transfer from the primary to the intermediate fluid occurs by conduction through the reactor vessel and wall. The two volumes remain permanently separated, and there is no need to breach any release barriers required for a proper application of the defence-in-depth principle. The proposed invention therefore considerably improves the robustness of decay heat removal arrangements of dual-vessel type reactors operating at low temperature.

### BRIEF DESCRIPTION OF THE DRAWINGS

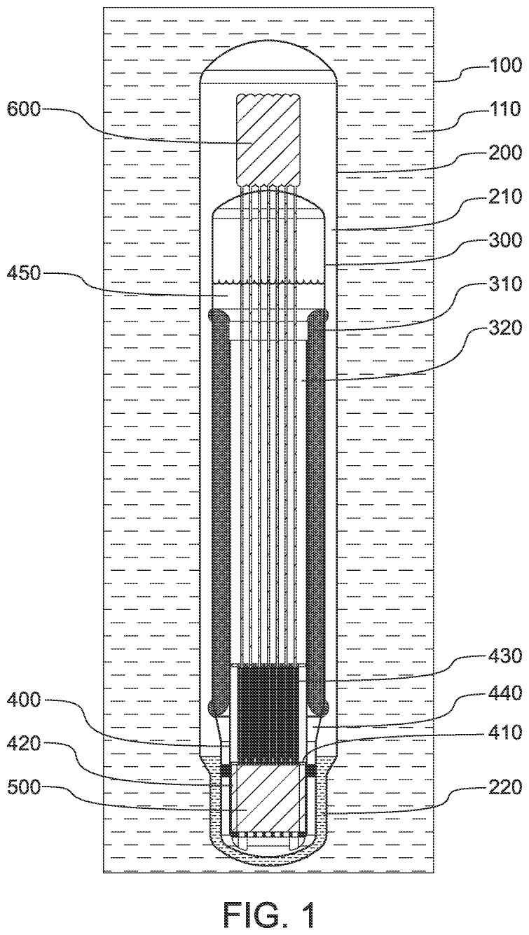

In the following certain embodiments of the invention are described in greater detail with reference to the accompanying drawings, in which FIG. 1 illustrates a schematic cross-sectional view of a nuclear district heating reactor in accordance with at least some embodiments of the present invention.

### EMBODIMENTS

In the present context the expression “permanently separated” refers, but is not limited, to the circulation of the primary fluid being permanently separated from the intermediate volume. This applies to all normal and anticipated operating occurrences and accidents, the exception being opening of an over-pressure valve to prevent catastrophic structural failure of the reactor vessel.

In the present context the expression “passive decay heat removal” refers to a heat removal system that does not depend on signal inputs, external power sources or forces, or moving mechanical parts, but does depend on moving working fluids. In other words, the passivity level corresponds to “category B passivity” as understood in the field and described in September 1991 issue of “Safety related terms for advanced nuclear plants” by the International Atomic Energy Agency (IAEA-TECDOC-626, ISSN 1011-4289, available online).

FIG. 1 illustrates a nuclear reactor module in accordance with at least some embodiments of the present invention. The module is placed in chamber 100 containing a pool of water acting as a heat sink 110 for heat originating from the module when the normal cooling path is unavailable. Under normal operation, the heat generated by the module is transferred through heat exchangers to an external secondary circuit (not illustrated in the drawings). The water in the pool may be at room temperature, e.g. typically between approximately 25 and 40° C. at atmospheric pressure. Alternatively, the heat sink may be a pool of another liquid, an air-cooled space, or bed of fluid granular material, such as sand or salt.

The module features a containment vessel 200 which is submerged into the heat sink 110. The containment vessel 200 is preferably completely submerged. The containment vessel 200 is an enclosure for housing a reactor vessel 300 which includes a reactor core 500 and the associated heat transfer componentry. The purpose of the containment vessel 200 is therefore to provide an intermediate volume 210 between the heat sink 110 and the reactor vessel 300 and to act as one of the barriers to the release of radioactive substances. The containment vessel 200 has a solid shell for preventing any fluid flow between the intermediate volume 210 inside the containment vessel 200 and the surrounding body of relatively cool substance, e.g. the ambient air or a pool of water, or a sand pit acting has a heat sink 110. The shell may have an elongated shape, such as a generally cylindrical shape with rounded ends for maximizing the ability to withstand pressure. The shell may be constructed of a metal, such as steel, particularly austenitic steel. The material preferably has good thermal conductivity properties. The containment vessel 200 does, however, include a sealed outlet and inlet for transferring heat between the reactor vessel 300 and an external consumer, but these components have been omitted from FIG. 1 for the sake of simplicity. Also, the containment vessel 200 may be secured or suspended to the chamber 100 by means of a mechanical connecting element which has been omitted from FIG. 1 for the sake of simplicity.

The intermediate volume 210 between the containment vessel 200 and the reactor vessel 300 is partially filled with an intermediate fluid 220. FIG. 1 shows the intermediate fluid level as being quite low. According to one embodiment, the intermediate fluid level is between the top of the reactor core 500 and the heat exchanger 310. The intermediate fluid 220 may be water, for example. The intermediate fluid 220 may be at or near ambient pressure at slight overpressure under normal operating conditions. A portion of the intermediate volume 210 is occupied by the intermediate fluid 220 under normal operating conditions. The amount of intermediate fluid 220 is selected such to provide a large enough heat transfer area. A typical level for the intermediate fluid 220 is below the bottom end of the heat exchanger which shall be discussed here after. The boiling point of the intermediate fluid 220 may be approximately 100° C. at approximately ambient pressure.

While the reactor vessel 300 and the containment vessel 200 may be constructed from a thermally conductive material, thermal insulation may be added to the lower part of the containment vessel 200. According to one embodiment the containment vessel 200 comprises a thermal insulation layer (omitted from the FIGURES) extending from the bottom of the containment vessel 200 up to the normal level of the intermediate fluid 220. The thermal insulation layer may, for example, extend from the bottom of the containment vessel 200 to between the reactor core 500 and the heat exchanger 310. The thermal insulation layer may be provided on the inner or outer surface of the containment vessel wall by spraying, for example. The purpose of the thermal insulation is to limit the heat flux between the reactor core 500 and the heat sink 110 in a normal operation mode.

The reactor vessel 300 is contained in the containment vessel 200 and secured or suspended to the containment vessel 200 by means of a mechanical connecting element which has been omitted from FIG. 1 for the sake of simplicity. The reactor vessel 300 has a sound shell for preventing any fluid flow between the inner volume of the reactor vessel 300 and the intermediate volume 210. The shell may have an elongated shape, such as a generally cylindrical shape with rounded ends for maximizing the ability to withstand pressure. The shell may be constructed of a metal, such as steel, particularly austenitic steel. The material preferably has good thermal conductivity properties.

The reactor vessel 300 contains the componentry required for maintaining a fission chain reaction for the purposes of generating heat, particularly for a district heating system. The basic structure of the reactor vessel 300 is relatively conventional for an integral pressurized water reactor. The preferable application of the invention is a nuclear district heating reactor which is run in relatively low temperatures. The reactor vessel 300 is pressurized to several bars, e.g. 5 bar. The reactor vessel 300 also contains a primary fluid 450. The primary fluid 450 may be water, for example. The boiling point of the primary fluid 450 is dependent on the pressure. The operating temperature is limited by the primary fluid 450 temperature at the downcomer 440, i.e. after the heat exchanger 310, which is kept below the boiling point of the intermediate fluid 220 in a normal operating mode.

The reactor vessel 300 houses a reactor core 500 placed at the bottom of the reactor vessel 300. The reactor core 500 may be a light water reactor core. The core may be fueled by uranium oxide pellets contained in a zirconium-based metal tube. Naturally, other fuels are also foreseeable. A core barrel 400 also placed inside the reactor vessel 300 envelops the reactor core 500 and the associated componentry, including a primary circuit. The primary circuit is associated with the reactor core 500 for extracting heat produced by the reactor core 500 and providing it to an external secondary circuit (not shown in the FIGURES). The primary circuit features a riser 320 for the hot water heated by the reactor core 500, a downcomer 440 around the riser 320 for returning the water to the reactor core 500, a heat exchanger 310 positioned in the downcomer 440 for absorbing the heat, and a primary fluid 450 contained in the reactor vessel 300 for transferring heat between the reactor core 500 and the heat exchanger 400.

The core barrel 400 has a perforated bottom plate for suspending the reactor core 500 in a flowing communication with the primary fluid 450. In other words, the reactor core 500 is submerged into the primary fluid 450. The reactor core 500 is secured into place by a top mounted support plate 410 which supports a guide tube 430 for a control assembly. A reflector 420 is provided around the reactor core 500 inside the core barrel 400 for improving the neutronic performance of the reactor core and reducing radiation load to the pressure vessel wall. The riser 320 forms a channel for upward coolant flow above the reactor core 500. The heat exchanger 310 is fitted to the space, particularly annular space, between the riser 320 and the reactor vessel 300 so as to be flushed by the primary fluid 450 being circulated inside reactor vessel 300 by the heating and cooling cycle of the primary fluid 450. Said space forms the downcomer 440 for the cooled fluid returning to the bottom chamber of the reactor vessel 200. The heat exchanger 310 may be a water-to-water heat exchanger with conduits (not illustrated in FIG. 1) penetrating the containment vessel for fluid communication with an external secondary circuit including a consumer, such as heat exchanger to tertiary circuit e.g. district heating circuit (not illustrated in FIG. 1). A control rod drive mechanism 600 is fitted at the top module, particularly into the top part of the intermediate volume 210 and connected to control rods via shafts going through guide tubes 430 through a sealed conduit provided to the reactor vessel 200.

The reactor primary circuit is fully enclosed inside the reactor vessel 300. The primary liquid 450 is heated in the reactor core 500. The flow is directed upwards inside the riser 320, which is located in the central part of the reactor vessel. The flow is then diverted downwards through heat exchangers 310, where the energy is transferred into the secondary side (omitted from the FIGURES). The coolant exits the heat exchangers at the bottom, flows through the downcomer 440, and re-enters the reactor core. The circulation can be forced, i.e., maintained by pumps, or based on natural convection, as in FIG. 1. The coolant temperature at the downcomer and core inlet is below 100° C. The core outlet temperature is around 120-150° C.

As mentioned above, the reactor module is run in relatively low temperatures. In the normal operation mode, the temperature of the primary fluid 450 at the riser 320 is in the range of 120 to 150° C. at approximately 5 to 10 bar. In the normal operation mode, the temperature of the primary fluid 450 at the downcomer 440, i.e. after being passed through the heat exchanger 310, is less than 100° C., when using water as the intermediate fluid 220. More specifically, the temperature of the primary fluid 450 at the downcomer 440 is below the boiling point of the intermediate fluid 220. In other words, the primary fluid temperature at the outlet of the heat exchanger 310 increases high enough to induce boiling of the intermediate fluid 220.

If the normal heat transfer path through the heat exchanger is compromised, heat produced in the reactor core 500 is trapped inside the reactor vessel 200. The reactor module will then inherently and without outside input switch to the passive decay heat removal mode. Temperature of the primary fluid 450 increases. The heat is conducted through the wall of the reactor vessel 200 causing the intermediate fluid 220 to heat up. Eventually the intermediate fluid 220 begins to boil, creating a very effective heat transfer passageway between the reactor core 500 and the heat sink 110. The thermally conductive properties of the containment vessel 200 further facilitate the conduction of heat through the containment vessel 200 to the heat sink 110. The heat capacity of the heat sink 110 is designed large enough to assume the heat potentially available of the reactor during an emergency shut down that may take several weeks. Reversal to normal operating mode is possible without any involvement either, whereby the reactor core 500 may be started or the process resumed once the temperatures of the primary fluid 450, intermediate fluid 220 and heat sink 110 have returned to an acceptable level.

According to a further embodiment the containment vessel 200 is pressurized to an overpressure. By increasing the pressure of the intermediate volume 210, the boiling point of the intermediate fluid 220 is also increased. For example, if water is used as the intermediate fluid 220, the boiling point of the intermediate fluid 220 could be more than 100° C., such as 110° C. The over pressure may be up to 5 bar. The amount of over pressure is chosen so that the boiling point of the intermediate fluid 220 is lower than the boiling point of the primary fluid 450.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the following description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The verbs “to comprise” and “to include” are used in this document as open limitations that neither exclude nor require the existence of also un-recited features. The features recited in depending claims are mutually freely combinable unless otherwise explicitly stated. Furthermore, it is to be understood that the use of “a” or “an”, i.e. a singular form, throughout this document does not exclude a plurality.

REFERENCE SIGNS LIST

| No. | Feature |
|---|---|
| 100 | chamber |
| 110 | heat sink |
| 200 | containment vessel |
| 210 | intermediate volume |
| 220 | intermediate fluid |
| 300 | reactor vessel |
| 310 | heat exchanger |
| 320 | riser |
| 400 | core barrel |
| 410 | support plate |
| 420 | reflector |
| 430 | guide tube |
| 440 | downcomer |
| 450 | primary fluid |
| 500 | reactor core |
| 600 | control rod drive mechanism |

### CITATION LIST

### Patent Literature

US 2010/0124303 A1

### Non-Patent Literature

“Safety related terms for advanced nuclear plants” by the International Atomic Energy Agency (IAEA-TECDOC-626, September 1991, ISSN 1011-4289)

1. A nuclear reactor module comprising:
a containment vessel;
a reactor vessel contained in the containment vessel, the reactor vessel comprising a primary circuit with a primary fluid, and
a reactor core contained in the reactor vessel and being cooled by the primary fluid,
wherein an intermediate volume is formed between the containment vessel and the reactor vessel, which intermediate volume is partially filled with an intermediate fluid, which is water, and
wherein the circulation of the primary fluid is permanently separated from the intermediate volume.

2. The nuclear reactor module according to claim 1, wherein the reactor vessel is configured to prevent all fluid flow between the reactor vessel and the containment vessel.

3. The nuclear reactor module according to claim 1, wherein the reactor vessel is made of steel, preferably austenitic steel.

4. The nuclear reactor module according to claim 1, wherein the passive removal of decay heat is not reliant on forced circulation of the primary fluid or actuation mechanical components.

5. The nuclear reactor module according to claim 1, wherein the primary fluid is water.

6. The nuclear reactor module according to claim 1, wherein the nuclear reactor module comprises a passive decay heat removal system provided by a heat conductive passageway between the reactor core and the surrounding ambient or heat sink, when the intermediate fluid is brought to its boiling point.

7. A nuclear district heating reactor, comprising a nuclear reactor module, wherein the nuclear reactor module comprises:
a containment vessel;
a reactor vessel contained in the containment vessel, the reactor vessel comprising a primary circuit) with a primary fluid, and
a reactor core contained in the reactor vessel and being cooled by the primary fluid,
wherein an intermediate volume is formed between the containment vessel and the reactor vessel, which intermediate volume is partially filled with an intermediate fluid, which is water, and
wherein the circulation of the primary fluid is permanently separated from the intermediate volume.

8. A method of operating a nuclear reactor module, wherein the nuclear reactor modules comprises:
a containment vessel;
a reactor vessel contained in the containment vessel, the reactor vessel comprising a primary circuit) with a primary fluid, and
a reactor core contained in the reactor vessel and being cooled by the primary fluid,
wherein an intermediate volume is formed between the containment vessel and the reactor vessel, which intermediate volume is partially filled with an intermediate fluid, which is water,
wherein the circulation of the primary fluid is permanently separated from the intermediate volume, and
wherein the method comprises keeping the circulation of the primary fluid separated from the intermediate volume.

9. The method according to claim 8, wherein the nuclear reactor module is operated in two modes, namely in:
a normal operation mode, in which the temperature of the primary fluid after passing through a heat exchanger is such, that the temperature of the intermediate fluid, heated by conduction through reactor vessel wall, is below the boiling point of the intermediate fluid, and in
a passive decay heat removal mode, in which:
the temperature of the primary fluid after passing through a heat exchanger is at or above the boiling point of the intermediate fluid, and
the temperature of the intermediate fluid is at the boiling point of the intermediate fluid,
wherein the hot primary and boiling intermediate fluid form a thermally conductive passageway between the nuclear core and the ambient or heat sink.

10. The method according to claim 9, further comprising, in the passive decay heat removal mode, cooling the wall of the containment vessel to a temperature below the boiling point of the intermediate fluid for facilitating efficient heat transfer via the intermediate fluid boiling at the reactor vessel wall and condensing to containment wall, this being the primary heat transfer mechanism for removing decay heat from the reactor core.

11. The method according to claim 9, wherein the core outlet temperature is 120 to 150° C.

12. The nuclear reactor module according to claim 1, wherein the intermediate fluid is in direct heat conducting contact with the reactor vessel.

13. The method according to claim 9, wherein the intermediate fluid is in direct heat conducting contact with the reactor vessel.
